(19) United States
(12) Patent Application Publication
(10) Pub. No.: US 2026/0351914 A1
(43) Pub. Date: Nov. 5, 2026

(54) Docking Station For Battery Crimping Tool

(71) Applicant: TE Connectivity Solutions GmbH, Schaffhausen (CH)

(72) Inventors: Mark Andrew Ondo, Middletown, PA (US); Philipp Christoph Knapp, Bensheim (DE); Christele Hoskote, Middletown, PA (US); Ibrahim Abdel-Mounaim, Tangier (MA); Abraham S. Whitcomb, Middletown, PA (US)

(73) Assignee: TE Connectivity Solutions GmbH, Schaffhausen (CH)

(21) Appl. No.: 19/665,257

(22) Filed: May 1, 2026

Related U.S. Application Data
(60) Provisional application No. 63/799,912, filed on May 5, 2025.

(51) Int. Cl. H01R 43/048; B21D 39/04

(52) U.S. Cl. CPC H01R 43/048; B21D 39/04

(57) ABSTRACT

A docking station for a battery-operated crimping tool includes a structural support frame, a tool interface, and a remote actuation system. The tool interface is mounted to an upper support arm of the structural support frame and includes complementary channels adapted to slidably receive mounting rails of the crimping tool, electrical contacts adapted to mate with power and signal terminals of the crimping tool, and at least one spring-loaded latch for locking the crimping tool to the interface. A power supply module provides continuous DC power to the crimping tool via the electrical contacts. The remote actuation system includes a control switch operatively connected to at least one of a mechanical actuator for physically engaging a trigger of the crimping tool and a controller for providing an electrical control signal to the crimping tool.

### CROSS-REFERENCE TO RELATED APPLICATION

This application claims priority under 35 U.S.C. § 119 to United States Provisional Patent Application No. 63/799, 912, filed on May 5, 2025.

### FIELD OF THE INVENTION

The present disclosure relates to a docking station apparatus for portable, battery-operated crimping tools, and more particularly, to a docking station that provides structural support, a continuous power supply and hands-free actuation when the tool is received in the docking station.

### BACKGROUND

Battery-operated crimping tools are widely used in electrical, telecommunications, and industrial applications for crimping terminals, connectors, lugs, and similar components onto conductors such as wires and cables. These portable crimping tools are powered by rechargeable battery packs and are designed for field use where mobility is important. A typical battery-operated crimping tool includes a motor-driven crimping mechanism, a trigger or actuator for initiating a crimping cycle, and a removable battery pack that provides electrical power to the motor.

While portable battery-operated crimping tools offer the advantage of mobility, they present several drawbacks in high-volume production or bench-top environments. For instance, a user performing repeated crimping operations at a workstation must continuously hold the tool, which can lead to user fatigue, repetitive strain injuries, and reduced productivity over extended work periods. Furthermore, the user must manually depress the trigger for each crimping cycle, requiring one hand to hold the tool and the other to position the workpiece, which can be ergonomically challenging and reduce the precision and consistency of the crimp.

Additionally, battery-operated tools are subject to power depletion during extended use. The battery pack must be periodically recharged or replaced, resulting in downtime that interrupts the production workflow. In high-volume applications, this downtime can be significant and costly.

To address the limitations of portable battery-operated crimping tools in stationary applications, some users resort to purchasing a separate dedicated bench-top crimping machine. However, this approach requires the expense of an additional tool, occupies additional workspace, and necessitates that the user learn to operate a different machine. The user is thus required to maintain and manage two separate tools for what is fundamentally the same crimping operation, depending on whether the application is portable or stationary.

Accordingly, there is a need for an apparatus and/or system that enables a single battery-operated crimping tool to function both as a portable handheld device and as a stationary bench-top crimping station, thereby eliminating the need for separate dedicated tools and providing ergonomic, productivity, and power-management advantages in stationary applications.

### SUMMARY

A docking station for a battery-operated crimping tool according to an embodiment of the present disclosure includes a base, a tool-to-stand interface, a power supply, and an actuation system. The tool-to-stand interface is supported by a structural support frame and is adapted to securely receive and hold the crimping tool in a fixed, operative orientation. The tool-to-stand interface includes complementary channels adapted to slidably receive mounting rails of the crimping tool, and at least one spring-loaded latch mechanism operable by a button for locking the crimping tool to the interface. The power supply is adapted to provide continuous electrical power to the crimping tool in place of, or in addition to, the tool’s battery, thereby enabling extended operation without battery depletion. The actuation system includes at least one of a foot switch and a hand-operated control adapted to remotely actuate the crimping cycle of the tool, thereby enabling hands-free operation of the tool while it is received in the docking station.

A docking station according to another embodiment of the present disclosure includes a structural support frame defining a tool-receiving area, a power supply module electrically connectable to a battery terminal interface of the crimping tool, a remote trigger mechanism, and an illumination system. The structural support frame is adapted to hold the crimping tool in a stable, stationary orientation suitable for bench-top crimping operations. The power supply module is adapted to deliver continuous DC power matching the voltage and current requirements of the crimping tool. The remote trigger mechanism includes a foot pedal operatively connected to an actuator adapted to engage the trigger of the crimping tool, thereby enabling a user to initiate a crimping cycle without manually holding or triggering the tool. The illumination system includes at least one light source positioned to illuminate a crimping area of the tool.

A method of operating a battery-operated crimping tool in a stationary mode according to another embodiment of the present disclosure includes the steps of: receiving the crimping tool in a docking cradle of a docking station such that the crimping tool is held in a fixed operative position; connecting a power supply of the docking station to the crimping tool for providing continuous electrical power thereto; positioning a workpiece in a crimping zone of the crimping tool; and actuating a crimping cycle of the crimping tool via a remote actuation device of the docking station, the remote actuation device being at least one of a foot switch and a hand-operated control.

### BRIEF DESCRIPTION OF THE DRAWINGS

The invention will now be described by way of example with reference to the accompanying Figures, of which:

FIG. 1 is a perspective view of a portable battery-operated crimping tool with a battery attached to a bottom portion thereof;

FIG. 2 is a perspective view of an exemplary battery of the type used by the crimping tool of FIG. 1;

FIG. 3 is a perspective view of a support structure or stand of the docking station according to an embodiment of the present disclosure;

FIG. 4 is a perspective view of a stand with the crimping tool attached thereto according to an embodiment of the present disclosure;

FIG. 5 is a bottom perspective view of the crimping tool showing a tool-side mounting interface including mounting rails and power/signal terminals;

FIG. 6 is a front elevational view of the bottom of the crimping tool showing the tool-side mounting interface;

FIG. 7 is a bottom perspective view of the tool-to-stand interface of the docking station;

FIG. 8 is a side elevational view of the tool-to-stand interface of FIG. 7; and

FIG. 9 is a block diagram of a power supply system of the docking station according to an embodiment of the present disclosure.

### DETAILED DESCRIPTION OF THE EMBODIMENTS

Exemplary embodiments of the present disclosure will be described hereinafter in detail with reference to the attached drawings, wherein like reference numerals refer to like elements. The present disclosure may, however, be embodied in many different forms and should not be construed as being limited to the embodiments set forth herein; rather, these embodiments are provided so that the present disclosure will convey the concept of the disclosure to those skilled in the art. In addition, in the following detailed description, for purposes of explanation, numerous specific details are set forth in order to provide a thorough understanding of the disclosed embodiments. However, it is apparent that one or more embodiments may also be implemented without these specific details.

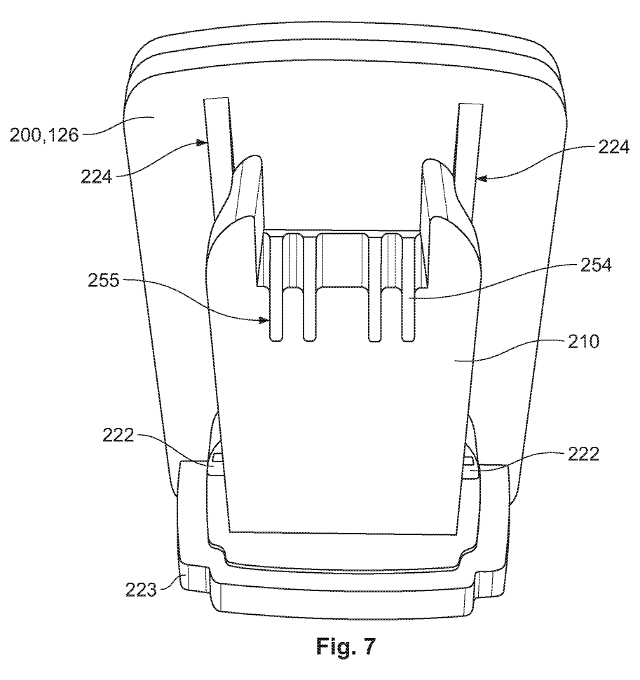

Referring generally to FIG. 1, a portable battery-operated crimping tool 10 of a type suitable for use with the docking station of the present disclosure is shown. The crimping tool 10 includes a housing 12, a crimping head 14 defining a crimping zone 16, a trigger or button 18 adapted to initiate a crimping cycle, a motor (not shown) arranged within the housing 12 for driving the crimping head 14, and a battery pack 20 (e.g., a 12V, 18V, 24V, 48V DC battery) removably connected to a bottom portion of the housing 12 for providing electrical power to the motor. As shown in FIG. 1, the battery pack 20 is attached to the bottom of the crimping tool 10 via a sliding engagement along a tool-side mounting interface 50 (shown in detail in FIGS. 6 and 7). In one embodiment, the crimping tool 10 is representative of commercially available battery-operated crimping tools and is shown for purposes of illustration. However, it should be understood that the docking station of the present disclosure may be adapted for use with various makes, models, and sizes of battery-operated crimping tools without departing from the scope of the disclosure. Further, embodiments of the present disclosure include a crimping tool having features not known to conventional devices, as will be described herein.

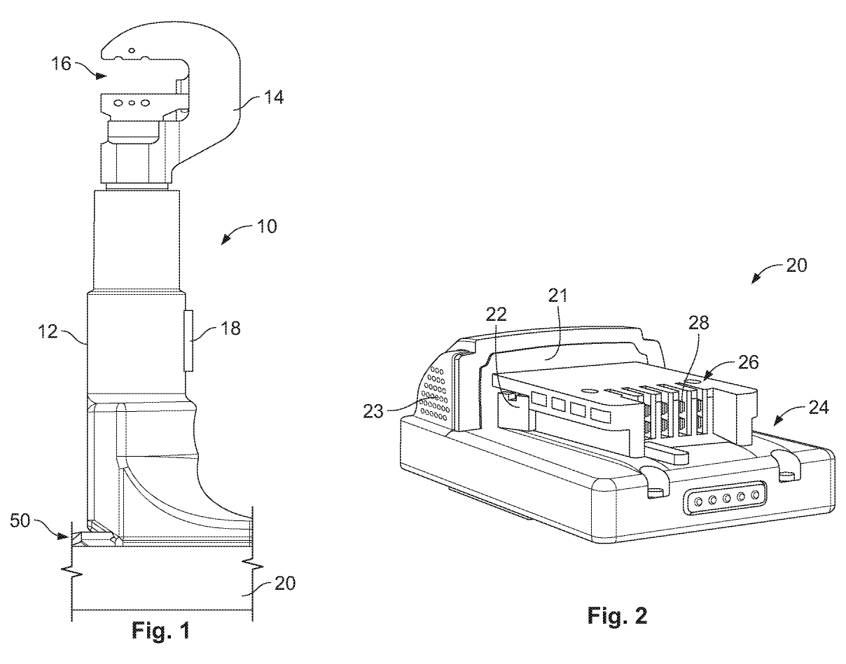

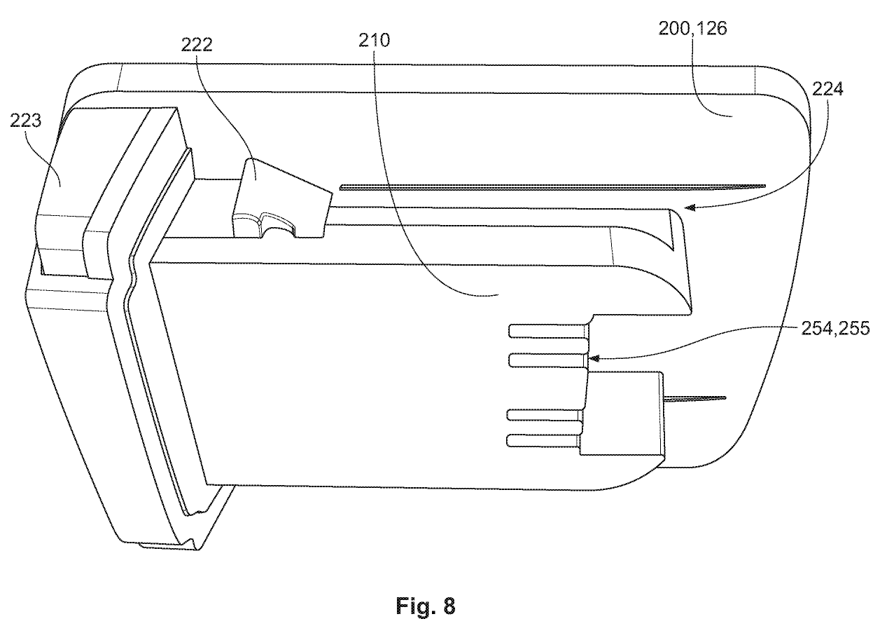

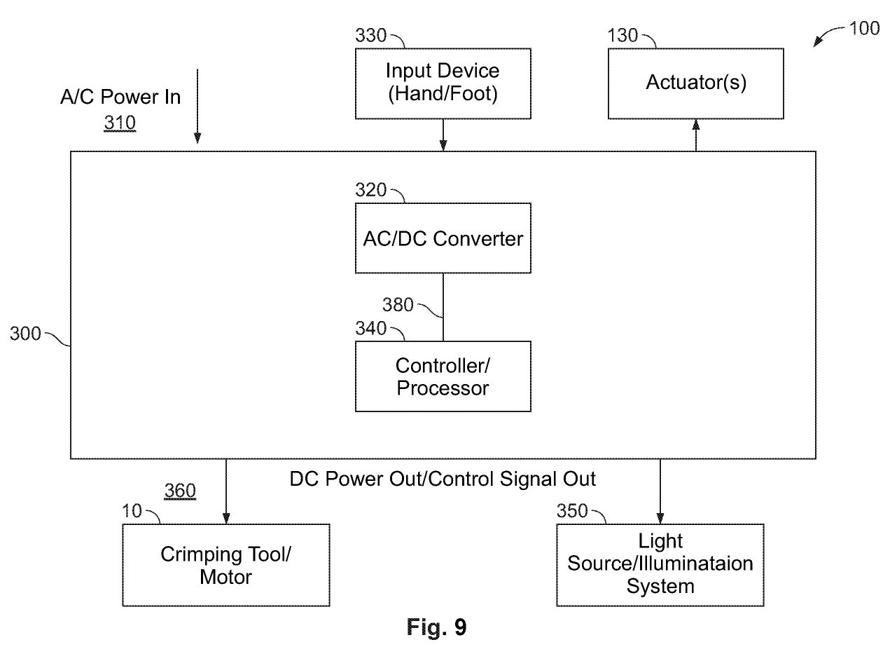

Referring now to FIG. 2, the battery or battery pack 20 is shown in greater detail. The battery 20 is an exemplary rechargeable battery of the type used to power the crimping tool 10 of FIG. 1. The battery pack 20 includes a housing 21, defining a plurality of contact or terminal openings 26 in which a plurality of conductive contacts 28 are arranged and adapted to mate with corresponding power and signal terminals 54 (FIGS. 6 and 7) on the crimping tool 10. The housing 21 further defines mating features, in this example, receiving channels 24 adapted to receive corresponding elements (e.g., mating rails 52, FIGS. 6 and 7) for fixedly attaching the battery 20 to the tool 10. The housing 21 further includes locking features, such as elastically biased or spring-loaded latches 22 and associated release buttons 23 for selectively locking and unlocking the battery 20 to and from the crimping tool 10. The battery 20 is adapted to be removably connected to the crimping tool 10 via a sliding engagement along the mounting rails 52 (FIGS. 6 and 7) of the tool-side mounting interface 50 and is lockable in position via the release buttons latches 22 engaging corresponding catch features on the crimping tool 10. As will be described herein, a docking station 100 of the present disclosure includes a tool-to-stand interface 200 (FIGS. 8 and 9) that mounts to the crimping tool 10 in a manner analogous to how the battery pack 20 mounts to the tool. Specifically, the tool 10 may be mounted to the interface 200is, via corresponding complementary channels 134 receiving the mounting rails 52 and spring-loaded latches 136 engaging latch features of the tool. In this way, the docking station interface 200 replaces or supplements the battery 20 at the bottom of the crimping tool 10 when the tool is docked.

The docking station 100 according to an embodiment of the present disclosure will now be described with reference to FIGS. 3-9. As shown in FIG. 3, the docking station 100 includes a structural support frame or stand 110. The stand 110 includes a base 120 adapted to rest upon a work surface such as a bench top, table, or other horizontal support. The base 120 is generally planar and may be formed from a rigid material such as steel, aluminum, or a heavy-duty engineering polymer. The base 120 defines mounting holes 122 at corners thereof, adapted to receive fasteners for optionally securing the docking station 100 to the work surface.

A vertical column 124 extends upwardly from the base 120 and provides structural support for the remaining components of the docking station 100. In the exemplary embodiment shown in FIG. 3, the vertical column 124 includes a plurality of longitudinal channels or ribs 125 along its exterior surface, which may provide additional rigidity and may serve as cable-management channels for routing power or signal wires from the base 120 to the upper portion of the stand 110.

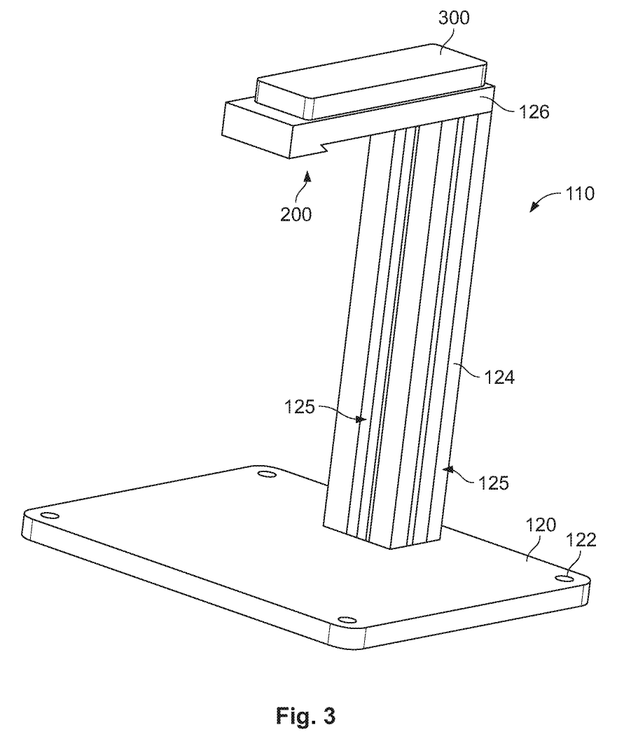

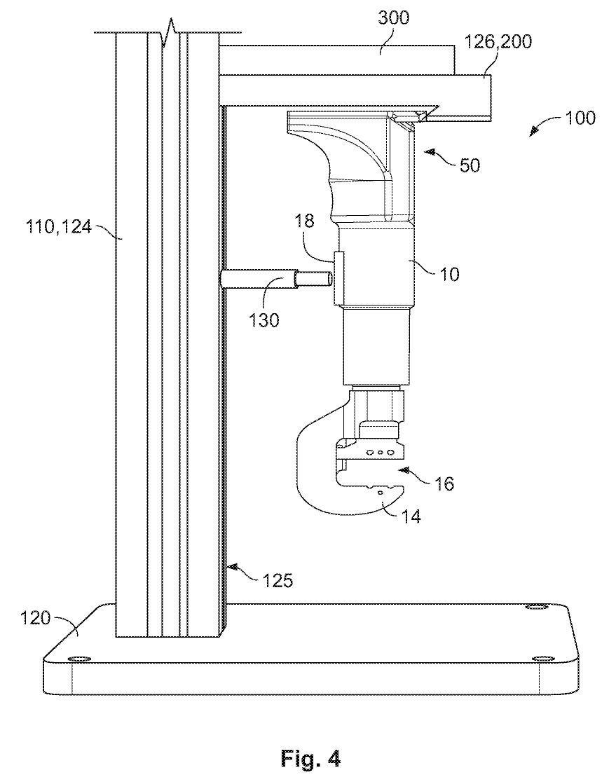

An upper support arm 126 extends generally horizontally from an upper end of the vertical column 124, forming a generally inverted-L or cantilevered shape. The upper support arm 126 supports the tool-to-stand interface 200 (FIGS. 7 and 8), as will be described in greater detail below. In some embodiments, the stand 110 may include height-adjustment provisions, such as a telescoping column arrangement or a plurality of mounting positions along the column 124, to accommodate different sizes and configurations of crimping tools. In another embodiment, as shown in FIG. 4, the support arm 126 may be slidably engaged with one of the vertical channels 125 for raising and lowering the interface 200 in the vertical direction.

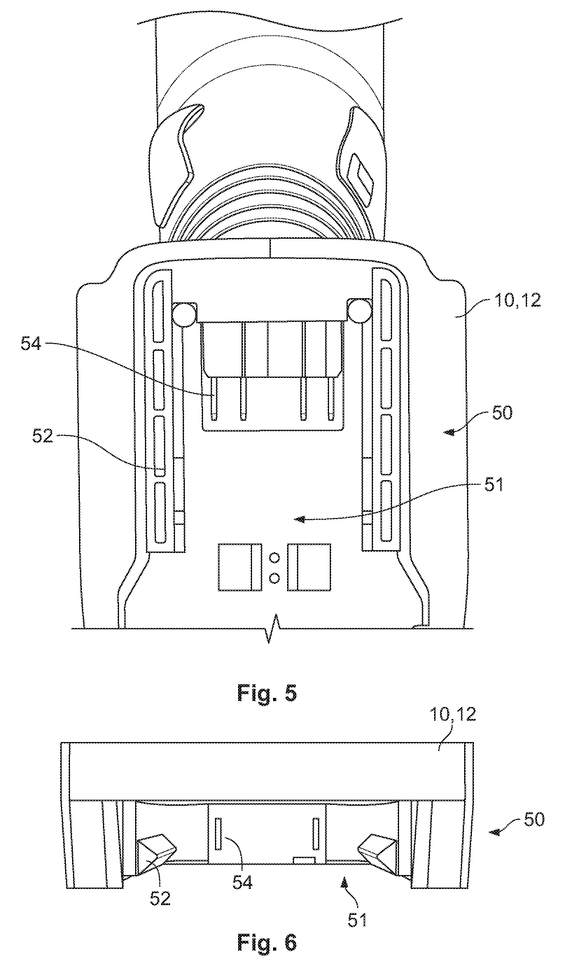

Referring now to FIG. 4, the docking station 100 is shown in an assembled state, wherein the crimping tool 10 is attached to the stand 110 via the tool-to-stand interface 200. In this embodiment, the tool-to-stand interface 200 may be integrally formed with the upper support arm 126, or it may be a separate member attached to an underside thereof. In the docked configuration of FIG. 4, the crimping tool 10 is oriented with the crimping head 14 and crimping zone 16 facing generally downward toward the base 110, and at a height suitable for a user to insert a workpiece (e.g., a wire and terminal) into the crimping zone 16 while standing or sitting at a workstation. The battery 20 has been removed from the crimping tool 10, and the tool-side mounting interface 50 (FIGS. 5 and 6) at the bottom of the crimping tool 10 is instead engaged with the tool-to-stand interface 200 at the upper support arm 126 of the stand 110.

As further shown in FIG. 4, an optional mechanical actuator 130 is positioned adjacent to the trigger or button 18 of the crimping tool 10. The actuator 130 is adapted to press or depress the trigger 18 of the crimping tool 10 in response to a signal from a remote actuation device, such as a foot pedal or hand switch operated by the user (described below with reference to FIG. 9). In this way, when the user activates the foot pedal or hand switch, the actuator 130 physically engages the trigger 18, thereby initiating a crimping cycle of the tool 10 without requiring the user to manually hold or trigger the tool. In one embodiment, the actuator 130 may be embodied as a solenoid, a servo motor, a pneumatic or hydraulic cylinder, a linear actuator, or a mechanical linkage. The actuator 130 may include adjustment provisions for accommodating different trigger positions and actuation forces across different crimping tool models. The actuator 130 may also be slidably mounted to the channel 125 of the column 124 for vertical adjustment.

In other embodiments, activation of a foot or hand control by the user is operative to control the function of the crimping tool 10 via an electrical control signal provided to the tool 10 via the power and signal terminals of the tool-to-stand interface 200, rather than by use of the physical actuator 130 as shown in FIG. 4. In such embodiments, the actuator 130 may be omitted, and a controller or processor 240 (FIG. 9) of a power supply module 300 of the docking station 100 may directly command the motor of the crimping tool 10 to perform a crimping cycle via the electrical interface of the tool-to-stand interface 200. This alternative embodiment will be described in greater detail with reference to the block diagram of FIG. 9. In the exemplary embodiment, the power supply module 300 is fitted to a top side of the support arm 126. In other embodiments, the power supply module 300 is integrally formed with the support arm 126 and/or the tool-to-stand interface 200 such that they are a single functional unit.

Referring now to FIGS. 5 and 6, the bottom of the crimping tool 10 is shown in detail. The crimping tool 10 defines the tool-side mounting interface 50 on the bottom portion of the housing 12. The tool-side mounting interface 50 is the same region to which the battery 20 is normally attached and from which it is removed. As shown in the bottom perspective view of FIG. 5, the tool-side mounting interface 50 includes a receiving opening 51 in which a pair of mounting features or mounting rails 52 extend in a longitudinal direction along opposite sides of the bottom of the housing 12. The mounting rails 52 are elongated protrusions adapted to slidably engage complementary channels 224 of the tool-to-stand interface 200 (FIGS. 7 and 8), in the same manner that the mounting rails 52 engage corresponding channels 24 of the battery 20 (FIG. 2). The receiving opening 51 is adapted to receive a complementary portion 210 of the tool-to-stand interface 200, as shown in FIGS. 7 and 8.

The tool-side mounting interface 50 further includes power, ground and/or signal terminals 54 arranged on the bottom of the housing 12 between or adjacent to the mounting rails 52. In the exemplary embodiment shown in FIG. 6, the power and signal terminals 54 include a plurality of conductive electrical contacts, such as blade-type or pin-type terminals. The power and signal terminals 54 are the same terminals to which the electrical contacts 28 of the battery 20 (FIG. 2) normally connect when the battery pack is installed on the crimping tool 10. In the context of the present disclosure, the power and signal terminals 54 serve as the electrical interface through which the docking station 100 provides DC power and, optionally, control signals to the crimping tool 10 in place of, or in addition to, the battery 20.

FIG. 6 shows a front elevational view of the bottom of the crimping tool 10, further illustrating the arrangement of the mounting rails 52 and the power/signal terminals 54 relative to the housing 12. As shown in FIG. 6, the mounting rails 52 extend laterally inwards from the bottom of the housing 12 and into the receiving space 51. The power/signal terminals 54 are recessed between the rails 52 in a generally central location within the receiving space 51.

Referring now to FIGS. 7 and 8, the tool-to-stand interface 200 of the docking station 100 is shown in detail. The tool-to-stand interface 200 provides the mechanical and electrical connection between the crimping tool 10 and docking station 100 and/or power supply or power supply module 300 thereof, and functions in a manner analogous to the battery, mounting to the tool-side mounting interface 50 via the same sliding engagement and latching mechanism used by the battery 20, in one embodiment of the present disclosure. It should be understood that in other embodiments, however, any suitable clamping or attachment mechanism may be used to secure the tool 10 to the stand 100, and/or electrically connect the power supply module 300 to the tool.

As shown in the bottom perspective view of FIG. 7, the tool-to-stand interface 200 includes mounting features, such as a pair of complementary channels 224 extending in a longitudinal direction. The channels 224 are sized and shaped to slidably receive the mounting features or mounting rails 52 of the tool-side mounting interface 50 (FIGS. 5 and 6) of the crimping tool 10, such that the crimping tool 10 may be slid into engagement with the tool-to-stand interface 200 in a manner analogous to how the battery 20 is mounted to the bottom of the crimping tool 10. The tool-to-stand interface 220 further includes electrical contacts 254 arranged in a position within respective terminal openings or slots 255 corresponding to the power and signal terminals 54 of the crimping tool 10. When the crimping tool 10 is fully received in the tool-to-stand interface 200, the electrical contacts 254 mate with the power and signal terminals 54 for delivering DC power and, optionally, control signals to the crimping tool 10 from the power supply module 300 of the docking station 100.

The tool-to-stand interface 200 further includes spring-loaded latches 222. The latches 222 are adapted to lock the crimping tool 10 to the tool-to-stand interface 200 once the mounting rails 52 are fully received in the channels 224, thereby securing the crimping tool 10 to the docking station 100 during operation. In one embodiment, the latches 222 are biased to a locked position by springs such that the crimping tool 10 is automatically locked upon full insertion into the interface 200. The latches 222 are operable by buttons 223, wherein depression of the buttons by a user releases the latches to an unlocked position, permitting the crimping tool 10 to be slid out of the interface 200 and returned to portable handheld use. This latch and button arrangement is analogous to the release buttons 23 of the battery 20 (FIG. 2), such that a user familiar with installing and removing the battery 20 from the crimping tool 10 will find the docking operation to be intuitive.

Referring to FIG. 8, a side elevational view of the tool-to-stand interface 200 is shown. As illustrated, the tool-to-stand interface 200 is mounted to, or forms an integral part of, the upper support arm 126 of the stand 110. In this arrangement, when the crimping tool 10 is slid into and locked to the tool-to-stand interface 220, the crimping tool 10 is thereby supported by the stand 110 in a fixed, stable, operative orientation suitable for bench-top crimping operations. The side view of FIG. 8 further illustrates the profile of the complementary channels 224, the electrical contacts 254 of the interface 20, and the release button 223 and associated latches 222.

Referring now to FIG. 10, a block diagram of a power supply system or module 300 of the docking station 100 is shown. The power supply module 300 includes an AC/DC converter 320 and a controller or control processor 340 operatively connected via, for example, a shared power and/or signal bus 380. The power supply 300 is responsive to an AC power source or input 310 and, optionally, an input device 330 for generating a DC output supply 360 to the crimping tool 10. The power supply module, and specifically the control processor 340 may be further operative to control the mechanical actuator 130, as well as a light source 350, which may be mounted to the stand 110, as described herein. The combination of the input device 330, the actuator 130 and/or the control processor 340 form a remote actuation system for the crimping tool 10.

The AC power source 310 represents a connection to a standard alternating current electrical outlet (e.g., 120V or 240V AC). The AC/DC converter 320 is electrically connected to the AC power source 310 and is adapted to convert the AC power to a regulated direct current (DC) output at a voltage and current matching the requirements of the crimping tool 10 (e.g., 12V, 18V, or 24V DC, depending on the tool model). The AC/DC converter 320 may include voltage regulation and current-limiting circuitry adapted to protect the crimping tool 10 and its internal electronics from damage due to overvoltage, overcurrent, or other electrical faults. In one embodiment, the AC/DC converter 320 may include a variable voltage output adapted to accommodate different models of crimping tools having different battery voltage ratings.

The input device 330 represents a user-operated control for initiating a crimping cycle and may include at least one of a foot switch or foot pedal, and a hand-operated control such as a push button, lever, or palm switch. The input device 330 is operatively connected to a controller or processor 340. When the user activates the input device 330 (e.g., by depressing the foot pedal or pressing the hand switch), the input device sends a signal to the controller 340.

The controller or processor 340 is adapted to receive the signal from the input device 330 and to control operation of the crimping tool 10 in response thereto. As shown in FIG. 9, the system 300 is operative to output at least DC power, and optionally a control signal, to the crimping tool 10 (i.e., to a motor thereof). In a first mode of operation, the controller 340 is operatively connected to the mechanical actuator 130, and in response to the signal from the input device 330, the controller 340 activates the actuator 130 to physically depress the trigger 18 of the crimping tool 10, thereby initiating the crimping cycle. In this mode, the DC output of the AC/DC converter 320 provides continuous power to the motor of the crimping tool 10 via the electrical contacts 254 of the tool-to-stand interface 200 and the power and signal terminals 54 of the crimping tool 10, while the actuator 130 provides the mechanical trigger input.

In a second mode of operation, the actuator 130 is omitted, and the controller 340 provides both DC power and a control signal to the crimping tool 10 via the electrical contacts 254 and the power and signal terminals 54 of the tool-to-stand interface 200. In this mode, the controller 340 directly commands the motor of the crimping tool 10 to perform a crimping cycle via the electrical control signal, without the need for a physical actuator to depress the trigger 18. The control signal may be, for example, a voltage or current signal applied to one or more of the signal terminals 54 that the crimping tool 10 interprets as a trigger command. This second mode of operation may simplify the mechanical design of the docking station 100 and may reduce the number of moving parts.

The controller 340 may further be adapted to monitor the status of the crimping tool 10, such as detecting completion of a crimping cycle, detecting fault conditions, or monitoring power consumption. The controller 340 may include indicator lights, a display, or audible indicators for conveying status information to the user.

In some embodiments, the docking station 100 further includes an illumination system 350 including at least one light source mounted on the stand 110 or the tool-to-stand interface 200 and positioned to illuminate the crimping zone 16 of the crimping tool 10 when the tool is received in the docking station 100. The light source may comprise one or more light-emitting diodes (LEDs) and may be adjustable in position and/or intensity. The illumination system 350 improves visibility of the crimping area, which enhances the precision and quality of the crimping operation and reduces the risk of improperly positioned workpieces. In one embodiment, the illumination system 350 is powered by the AC/DC converter 320 of the system 300. In another embodiment, the illumination system 350 may include a magnification lens or loupe positioned proximate the crimping zone 16 for assisting the user in viewing small workpieces and ensuring proper alignment.

In operation, a user transitions the crimping tool 10 from a portable mode to a stationary bench-top mode as follows. First, the user removes the battery 20 from the crimping tool 10 by depressing the release buttons 23 (FIG. 2) and sliding the battery 20 off of the mounting rails 52 (FIGS. 5 and 6) of the tool-side mounting interface 50. Next, the user slides the crimping tool 10 into the tool-to-stand interface 200 (FIGS. 7 and 8) of the docking station 100 by engaging the mounting rails 52 of the tool-side mounting interface 50 with the complementary channels 234 of the tool-to-stand interface 200. The spring-loaded latches 222 automatically lock the crimping tool 10 to the interface 200 upon full insertion. At this point, the electrical contacts 254 of the interface 200 are mated with the power and signal terminals 54 of the crimping tool 10, and the docking station 100 provides continuous DC power to the crimping tool 10 via the AC/DC converter 320 (FIG. 10).

With the crimping tool 10 docked and powered, the user positions a workpiece in the crimping zone 16 of the crimping head 14 and actuates the crimping cycle by activating the input device 330 (e.g., by depressing a foot pedal or pressing a hand switch). Depending on the configuration of the docking station 100, the controller 340 either activates the mechanical actuator 130 to depress the trigger 18, or provides a direct electrical control signal to the motor of the crimping tool 10 via the tool-to-stand interface 200 to initiate the crimping cycle. The crimping tool 10 performs the crimping cycle under continuous power from the AC/DC converter 320, and the user may repeat the process for successive workpieces without the need to hold the tool, manually trigger the tool, or manage battery life.

When the user wishes to return the crimping tool 10 to portable mode, the user depresses the buttons 223 of the spring-loaded latches 222 to unlock the crimping tool 10 from the tool-to-stand interface 200, slides the crimping tool 10 out of the interface, reinstalls the battery 20 onto the tool-side mounting interface 50, and uses the crimping tool 10 in the conventional handheld manner.

The foregoing illustrates some of the possibilities for practicing the invention. Many other embodiments are possible within the scope and spirit of the invention. It is, therefore, intended that the foregoing description be regarded as illustrative rather than limiting, and that the scope of the invention is given by the appended claims together with their full range.

Also, the indefinite articles “a” and “an” preceding an element or component of the invention are intended to be nonrestrictive regarding the number of instances, that is, occurrences of the element or component. Therefore “a” or “an” should be read to include one or at least one, and the singular word form of the element or component also includes the plural unless the number is obviously meant to be singular.

The term “invention” or “present invention” as used herein is a non-limiting term and is not intended to refer to any single embodiment of the particular invention but encompasses all possible embodiments as described in the application.

What is claimed is:

1. A docking station for a battery-operated crimping tool, comprising:
a structural support frame including a base and an upper support arm; and
an interface supported by the upper support arm and including:
mounting features adapted to receive corresponding mounting features of the crimping tool; and
electrical contacts adapted to mate with corresponding electrical contacts of the crimping tool.

2. The docking station of claim 1, further comprising a remote actuation system including at least one of a foot or hand operated control switch, the remote actuation system operatively connected to at least one of an actuator adapted to physically engage a trigger of the crimping tool and a controller adapted to provide an electrical control signal to the crimping tool via the power and signal terminals for initiating a crimping cycle thereof.

3. The docking station of claim 2, further comprising a controller adapted to receive a signal from the control switch and, in response thereto, control operation of the crimping tool via at least one of the actuator and the electrical control signal.

4. The docking station of claim 3, wherein the controller is adapted to directly command a motor of the crimping tool to perform a crimping cycle via the electrical control signal provided through the electrical contacts of the interface and the power and signal terminals of the crimping tool, without use of the actuator.

5. The docking station of claim 3, wherein the controller is adapted to activate the actuator to physically depress the trigger of the crimping tool in response to the signal from the control switch.

6. The docking station of claim 1, wherein the interface further includes at least one spring-loaded latch adapted to lock the crimping tool to the interface, the at least one spring-loaded latch is operable by a button, and wherein depression of the button by a user releases the latch to an unlocked position for permitting removal of the crimping tool from the interface.

7. The docking station of claim 1, wherein the mounting features include complementary channels are sized and shaped to receive mounting rails of the crimping tool via a sliding engagement.

8. The docking station of claim 1, further comprising a power supply module mounted to the frame and adapted to provide continuous DC electrical power to the crimping tool via the electrical contacts of the tool-to-stand interface.

9. The docking station of claim 8, wherein the power supply module includes an AC/DC converter adapted to receive alternating current power from an electrical outlet and convert the alternating current power to direct current power at a voltage and current matching requirements of a battery of the crimping tool.

10. The docking station of claim 8, wherein the power supply module includes a variable voltage output adapted to accommodate crimping tools having different battery voltage ratings.

11. The docking station of claim 1, further comprising an illumination system including at least one light source positioned to illuminate a crimping zone of the crimping tool when the crimping tool is received in the interface.

12. The docking station of claim 1, wherein the interface is mounted to, or forms an integral part of, the upper support arm of the structural support frame.

13. The docking station of claim 1, wherein the actuator comprises at least one of a solenoid, a servo motor, a pneumatic cylinder, a linear actuator, and a mechanical linkage.

14. A docking station for a portable crimping tool, comprising:
a structural support frame including a base and a vertical column extending upwardly from the base, and an upper support arm extending from the vertical column;
a tool interface arranged at the upper support arm and adapted to receive the crimping tool, the tool interface including mounting features adapted to selectively mate with corresponding mounting features of the crimping tool, and electrical contacts adapted to mate with power and signal terminals of the crimping tool; and
a controller adapted to receive a signal from an input device and to control operation of the crimping tool in response thereto.

15. The docking station of claim 14, wherein the controller is adapted to control operation of the crimping tool via at least one of:
activating a mechanical actuator to physically engage a trigger of the crimping tool; and
providing an electrical control signal to the crimping tool via the electrical contacts and the power and signal terminals.

16. The docking station of claim 14, wherein the tool interface is adapted to receive the crimping tool via the same engagement by which a battery of the crimping tool is mounted to the crimping tool.

17. The docking station of claim 14, further comprising an illumination system including at least one light source positioned to illuminate a crimping area of the crimping tool when the crimping tool is received in the tool-to-stand interface.

18. The docking station of claim 14, further comprising a power supply module including an AC/DC converter for delivering continuous DC power to the crimping tool via the electrical contacts of the tool-to-stand interface.

19. A method of operating a battery-operated crimping tool in a stationary mode, comprising:
removing a battery from a tool-side mounting interface of the crimping tool, the tool-side mounting interface including mounting elements, and conductive terminals;
engaging the mounting elements of the crimping tool with complementary mounting elements of a tool-to-stand interface of a docking station;
locking the crimping tool to the tool-to-stand interface;
positioning a workpiece in a crimping zone of the crimping tool; and
actuating a crimping cycle of the crimping tool.

20. The method of claim 19, wherein actuating the crimping cycle includes at least one of:
activating a mechanical actuator to physically depress a trigger of the crimping tool; and
providing an electrical control signal to the crimping tool via the tool-to-stand interface.
